(19) United States
(12) Patent Application Publication
(10) Pub. No.: US 2005/0152574 A1
(43) Pub. Date: Jul. 14, 2005

(54) Receiver having an improved bobbin

(76) Inventors: Stephan Olivier Van Banning, IJmuiden (NL); Alwin Fransen, Delft (NL); Paul Christiaan Van Hal, Amsterdam (NL)

Correspondence Address: JENKENS & GILCHRIST, P.C., 225 WEST WASHINGTON, SUITE 2600, CHICAGO, IL, 60606, US

(21) Appl. No.: 10/756,589

(22) Filed: Jan. 13, 2004

(51) Int. Cl. H04R 1/00; H04R 11/02; H04R 9/06

(52) U.S. Cl. 381/417; 381/407; 381/400; 381/411

(57) ABSTRACT

A receiver is disclosed for use in listening devices, such as hearing aids. The receiver comprises an electromagnetic drive assembly that includes a bobbin having a coil of conductive wire formed thereon. The bobbin is capable of compensating for the deflections on the armature that may be caused by shock. The bobbin is also capable of centering an armature leg within the coil.

### FIELD OF THE INVENTION

The present invention relates to miniature receivers used in listening devices, such as hearing aids. In particular, the present invention relates to miniature receivers that have an improved coil-receiving section.

### BACKGROUND OF THE INVENTION

A conventional listening device such as a hearing aid includes, among other things, a microphone, an amplifier, and a receiver. The microphone receives an acoustic signal (i.e., sound waves) from the surrounding environment and converts the acoustic signal into an electrical signal. The electrical signal is then processed (e.g., amplified) by the amplifier and provided to the receiver. The receiver converts the processed electrical signal back into an acoustic signal and subsequently broadcast the acoustic signal to the eardrum.

A receiver for a conventional listening device is shown in FIG. 1. As can be seen, the receiver 100 includes a housing 102 that protects the sensitive components mounted inside the receiver 100. The housing 102 may be of a size and shape that allows the receiver 100 to be used in miniature listening devices, such as hearing aids. Within the housing 102 is mounted an electromagnetic drive assembly 104 that converts electrical signals from a microphone into acoustic signals. The electromagnetic drive assembly 104 includes, among other things, an armature 108 and an electrically conductive coil 110 through which the electrical signals from the microphone pass. Lead wires (not visible here) from the coil 110 extend through an opening in the housing 102 and terminate at a terminal 111 (e.g., a solder bump) on the outside of the receiver 100.

A magnet assembly 114 is also included in the electromagnetic drive assembly 104 adjacent to the coil 110. The magnet assembly 114 has a magnet housing composed of a pair of housing elements 116a and 116b. The housing elements 116a and 116b hold a pair of magnets (not visible here) that define a magnetic gap through which the working portion of the armature 108 extends.

In operation, an electrical signal passing through the coil 110 induces a magnetic field around the armature 108. Variations in the electrical signal produces fluctuations in the magnetic field, causing the armature 108 to alternate between moving toward one or the other of the magnets. A diaphragm 118 converts the armature movements, via a drive pin (not visible here), into a corresponding acoustic signal that is then broadcast to the eardrum.

The armature 108 is E-shaped, for example, with a base from which three parallel legs extend. Mounting of the armature 108 is such that the middle leg or reed of the armature passes through the center of the coil 110 along a central axis thereof, while the outer legs extend along the outside of the coil 110. The ends of the armature legs are then attached to the magnet assembly 114, which is adjacent to the coil 110.

Coil formation typically involves winding a conductive wire around a coil former. A coil winding bobbin may also be used to form the coil. Epoxy is usually applied to the coil to prevent corrosion. The coil former or coil winding bobbin is then removed using tweezers or other similar instruments. For an example of a coil winding bobbin that is removed, see European patent EP1219135B1. Removal of the coil former or coil winding bobbin, however, often produces inadvertent contact between the tweezers and the coil. This contact may cause damage to the epoxy, which can result in corrosion of the coil.

One solution to the above problem is to form the coil around a bobbin that is not removed. The middle armature leg or reed is then passed through the center of the bobbin and the outer legs extend along the outside. This solution, however, is lessened by the fact that it is usually very difficult to precisely center the middle armature leg within the bobbin. As a result, the inner height of the bobbin is typically made much larger than what is actually needed to accommodate the normal vibration of the armature leg.

Moreover, the armature 108 in the conventional receiver 100 is supported only at the ends of the legs where they are attached to the magnet assembly 114. The rest of the armature 108 is unsupported. As a result, large deflections may occur on the armature 108 when the receiver 100 is subjected to shock. A sufficiently severe shock may cause the armature 108 to deflect beyond the point of elastic deformation, thereby compromising the operation of the receiver 100.

Accordingly, what is needed is a receiver that is capable of inhibiting the large armature deflections that usually accompany a shock, and that is also capable of centering an armature leg within the coil of the receiver.

### SUMMARY OF THE INVENTION

The present invention is directed to an improved receiver for use in listening devices, such as hearing aids. The receiver comprises an electromagnetic drive assembly that includes a bobbin having a coil of conductive wire formed thereon. The bobbin is capable of inhibiting the deflections on the armature that may be caused by shock. The bobbin is also capable of centering an armature leg within the coil.

In one embodiment, the receiver includes a magnet assembly, an armature having a moveable leg, and a coil assembly. The coil assembly includes a bobbin and a conductive wire wound around the bobbin. The coil assembly is adjacent to the magnet assembly and, together with the magnet assembly, defines a passage through which the moveable leg of the armature passes. The bobbin includes an inner surface defining the passage. The inner surface has at least one shock-absorbing structure for limiting a movement of the moveable leg within the passage when the receiver is subjected to shock.

In another embodiment, the receiver includes a magnet assembly, an armature having a moveable portion and a fixed portion, and a coil assembly. The coil assembly includes a bobbin and a conductive wire wound around the bobbin. The coil assembly is adjacent to the magnet assembly and, together with the magnet assembly, defines a passage through which the moveable leg passes. The bobbin includes an armature-mounting structure, usually in the form of slots in flanges of the bobbin. The moveable portion of the armature is substantially centered within the passage in response to the fixed portion being engaged to the armature-mounting structure.

The above summary of the present invention is not intended to represent each embodiment, or every aspect, of the present invention.

### BRIEF DESCRIPTION OF THE DRAWINGS

The foregoing and other advantages of the invention will become apparent upon reading the following detailed description and upon reference to the drawings, wherein:

FIG. 1 illustrates a cutaway view of a prior art receiver.

FIGS. 2A-2B illustrate a cutaway view and a cross-sectional view, respectively, of a receiver having a shock-absorbing bobbin according to embodiments of the invention;

FIG. 3 illustrates a cross-sectional view of a receiver having another shock-absorbing bobbin according to another embodiment of the invention;

FIG. 4 illustrates a cross-sectional view of a receiver having an armature-centering bobbin according to yet another embodiment of the invention;

FIG. 5 illustrates a cross-sectional view of a receiver having a wire guiding bobbin according to a further embodiment of the invention;

FIG. 6 illustrates a cross-sectional view of a receiver having a shock-absorbing, armature-centering, and wire guiding bobbin according to yet another embodiment of the invention; and

FIG. 7 illustrates a perspective view of an electromagnetic drive assembly according to embodiments of the invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

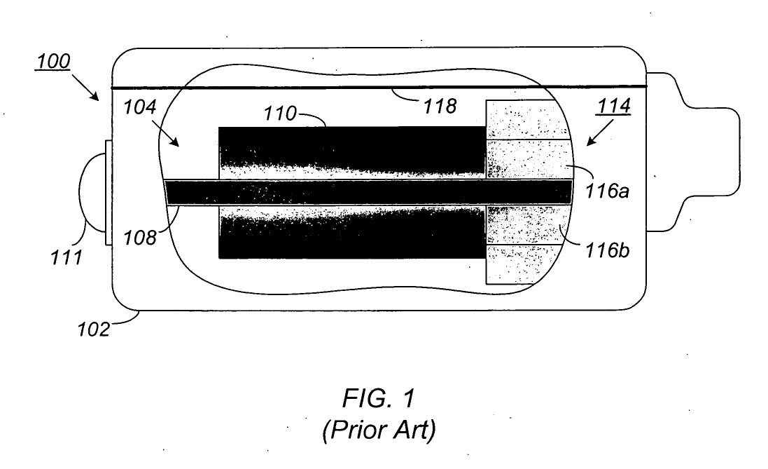

As mentioned above with respect to prior art FIG. 1, conventional receivers typically employ coil formers or coil winding bobbins that are removed. In contrast, the receiver of the present invention uses a bobbin that is not removed. Thus, throughout the remainder of this description, the term “bobbin” will be used to refer to a bobbin that stays in the receiver.

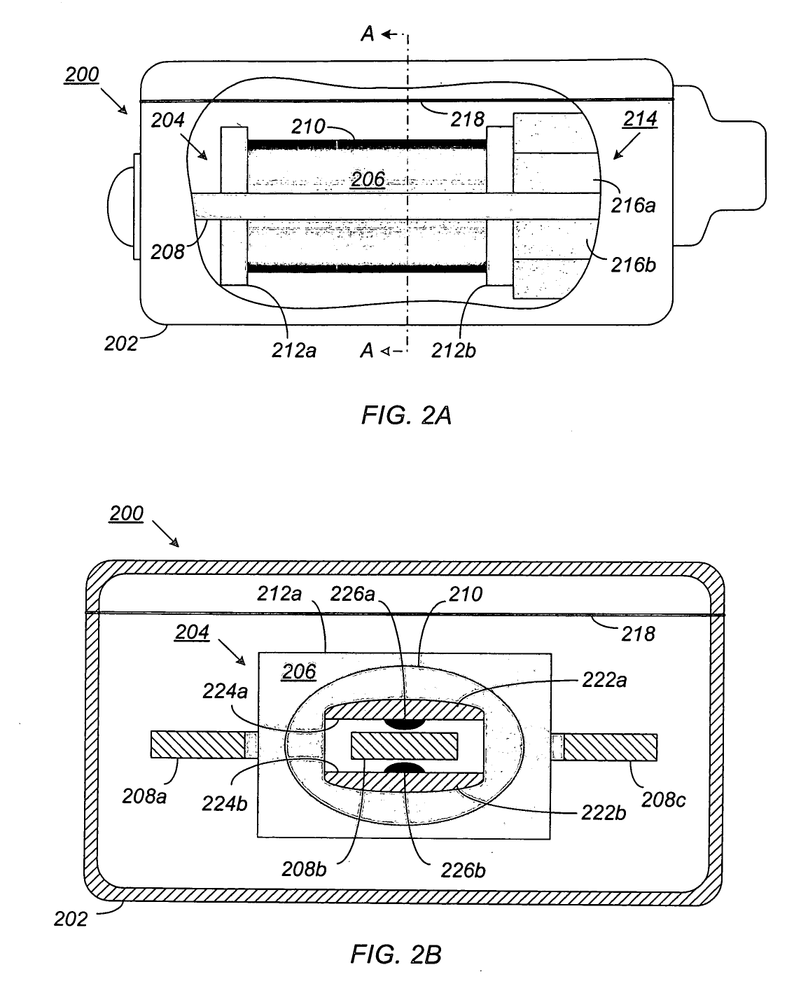

Referring now to FIG. 2A, a cutaway view of a receiver 200 according to embodiments of the invention is shown. The receiver 200 has many of the same components found in the receiver 100 of FIG. 1, including a housing 202 that protects sensitive electronic components mounted inside the receiver 100. Within the housing 202 is mounted an electromagnetic drive assembly 204 that includes, among other things, a bobbin 206 and an armature 208 mounted on the bobbin 206. A coil 210 of conductive wire is wound around the bobbin 206 between a first flange 212a and a second flange 212b of the bobbin 206. The first and second flanges 212a and 212b serve as retainers for the coil 210 during formation thereof. A magnet assembly 214 is also included that comprises a pair of housing elements 216a and 216b. The housing elements 216a and 216b hold a pair of magnets (not visible here) that define a magnetic gap through which the working portion of the armature 208 extends. A diaphragm 218 converts the vibrations from the armature 208 via a drive pin (not visible here) into a corresponding acoustic signal that is then broadcast to the eardrum.

FIG. 2B illustrates a cross-sectional view of the receiver 200 taken along the line A-A in FIG. 2A. As can be seen in this view, the armature is an E-shaped armature with three parallel legs 208a, 208b, and 208c. The outer armature legs 208a and 208c extend along an outside of the bobbin 206, while the middle armature leg 208b or reed extends through a center longitudinal axis of the bobbin 206 and also through the magnetic gap defined by the pair of magnets that are adjacent to the bobbin 206. Note that although an E-shaped armature is used here, it is also possible to use other types of armatures (e.g., a single-leg armature or a U-shaped armature that has two legs) without departing from the scope of the invention.

The bobbin 206, meanwhile, includes a coil-receiving portion 222 that is made of parallel coil-receiving members 222a and 222b, which connect the two flanges 212a and 212b together. The coil 210 is then formed by winding a conductive wire around the coil-receiving members 222a and 222b. The coil-receiving members 222a and 222b have respective inner surfaces 224a and 224b that, together with the coil 210, define a passageway in the bobbin 206 through which the middle armature leg 208b extends. The bobbin 206 is made of a material, such as liquid crystal polymer (LCP), which will not affect the electromagnetic field produced by the coil. Other materials that may be used include, for example, a polyamide/nylon material, such as Stanyl®.

The inner surfaces 224a and 224b of the coil-receiving members 222a and 222b have one or more shock-absorbing structures 226a and 226b mounted thereon. The shock-absorbing structures 226a and 226b are preferably mounted substantially directly over the middle armature leg 208b on the respective inner surfaces 224a and 224b such that the structures can absorb any deflections that may occur on the middle armature leg 208b. In this way, the shock-absorbing structures 226a and 226b serve to limit the amount of deflection available to the middle armature leg 208b when the receiver 200 is subjected to shock.

Locating the shock-absorbing structures 226a and 226b on the coil-receiving members 222a and 222b has the advantage of ease of manufacture. It is also possible to locate the shock-absorbing structures 226a and 226b on the magnets. In general, however, it is preferable to keep the shape of the magnets as simple as possible because magnets are often tumbled or barrel polished, which may influence or alter the dimensions of any shock-absorbing structures that are formed on the magnets.

In some embodiments, there is a slight gap between the middle armature leg 208b and each shock-absorbing structure 226a and 226b. The gap on one side of the middle armature leg 208b may or may not be the same size as the gap on the other side, depending on whether the middle armature leg 208b is centered or off-center within the bobbin 206. It is also possible to have no gap, i.e., the middle armature leg 208b is in direct contact with one or both of the shock-absorbing structures 226a and 226b so long as the structures are sufficiently elastic to allow the armature to perform its function.

As for the composition of the shock-absorbing structures 226a and 226b, these structures may be made of any suitable shock-absorbing material. For example, in some embodiments, the shock-absorbing structures 226a and 226b may be made of an elastomeric material, such as a silicon based adhesive. In other embodiments, the shock-absorbing structures 226a and 226b may be formed from drops of a cured adhesive. One example of such a cured adhesive is the UV-cured adhesive OG115 from Epoxy Technology, Inc. of Billerica, Mass., with a Shore D hardness of approximately 86. In still other embodiments, the shock-absorbing structures 226a and 226b are integrally formed on the bobbin 206 and, thus, made from the same material as the bobbin 206.

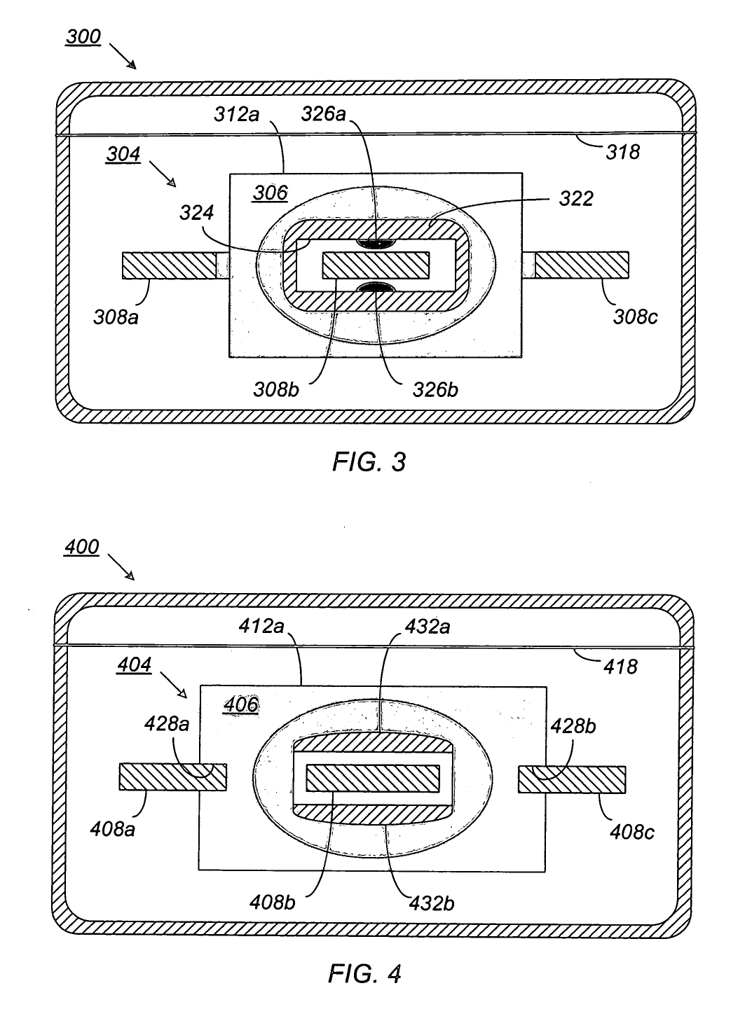

FIG. 3 illustrates a cross-sectional view of a receiver 300 having an electromagnetic drive assembly 304 according to embodiments of the invention. The electromagnetic drive assembly 304 is similar to the electromagnetic drive assembly 204 of FIGS. 2A-2B, except that it has a bobbin 306 which includes a substantially tubular coil-receiving portion 322. The result is that an inner surface 324 of the coil-receiving portion 322 alone defines the entire passageway in the bobbin 306. This is different from the previous embodiment in which the coil 210 and the coil-receiving members 222a and 222b together define the passageway. Such a coil-receiving portion 322 may also help improve the stiffness of the bobbin 306. Shock-absorbing structures 326a and 326b are then mounted on opposing sides of the inner surface 324 of the unitary coil-receiving portion 322 substantially directly over the middle armature leg 308b such that the structures can absorb the deflections that may occur on the armature leg.

In some embodiments, instead of (or in addition to) the shock-absorbing structures, the bobbin may include an armature support structure that helps brace or stiffen the outer armature legs and also helps suppress the deflections that may occur on the armature legs. FIG. 4 illustrates a cross-sectional view of a receiver 400 having an electromagnetic drive assembly 404 with an exemplary armature support structure on the bobbin. The electromagnetic drive assembly 404 is similar to the electromagnetic drive assembly 204 of FIGS. 2A-2B, except that it has a bobbin 406 which includes armature-mounting slots 428a and 428b. These armature-mounting slots 428a and 428b are formed on the flanges 412a and 412b (only one shown in FIG. 4) on the sides thereof that are substantially perpendicular to the plane of the armature (one slot on each side).

The armature-mounting slots 428a and 428b are designed to receive at least a portion of the outer armature legs 408a and 408c and to provide bracing and stiffness support for the outer armature legs 408a and 408c. To this end, the size and shape of the armature-mounting slots 428a and 428b should be of a dimension such that at least a portion of each outer armature leg 408a and 408c can fit snugly in one of the armature-mounting slots 428a and 428b. Likewise, the flanges 412a and 412b should have a width that is large enough to intersect at least a portion of the outer armature legs 408a and 408c. When the outer armature legs 408a and 408c are properly engaged in the armature-mounting slots 428a and 428b, the armature becomes supported at more than one place. This additional support provides improved stiffness for the outer armature legs 408a and 408c and, to a lesser degree, the middle armature leg 408b as well.

In addition to improving stiffness, the support provided by the armature-mounting slots 428a and 428b also helps dampen the deflections that may be present on the outer armature legs 408a and 408c. Dampening of deflections may also take place on the middle armature leg 408b, although to a lesser degree. As a result, it may not be necessary to provide a separate set of shock-absorbing structures to compensate for deflection on the armature legs, although it is certainly possible to have both.

Furthermore, the armature-mounting slots 428a and 428b also have the effect of automatically centering the middle armature leg 408b within the bobbin 406. The reason is because the engagement of the outer armature legs 408a and 408c in the armature-mounting slots 428a and 428b naturally forces the middle armature leg 408b to be located in a certain position. By selecting the proper placement for the armature-mounting slots 428a and 428b on the flanges 412a and 412b, the middle armature leg 408b can be automatically positioned in the center on the bobbin 406. This reduces the need to overcompensate for an off-center armature leg by, for example, providing extra room between the armature leg 408b and the inner surface of the coil-receiving members 422a and 422b. The self-centering armature also results in a receiver that is easier to manufacture than existing receivers.

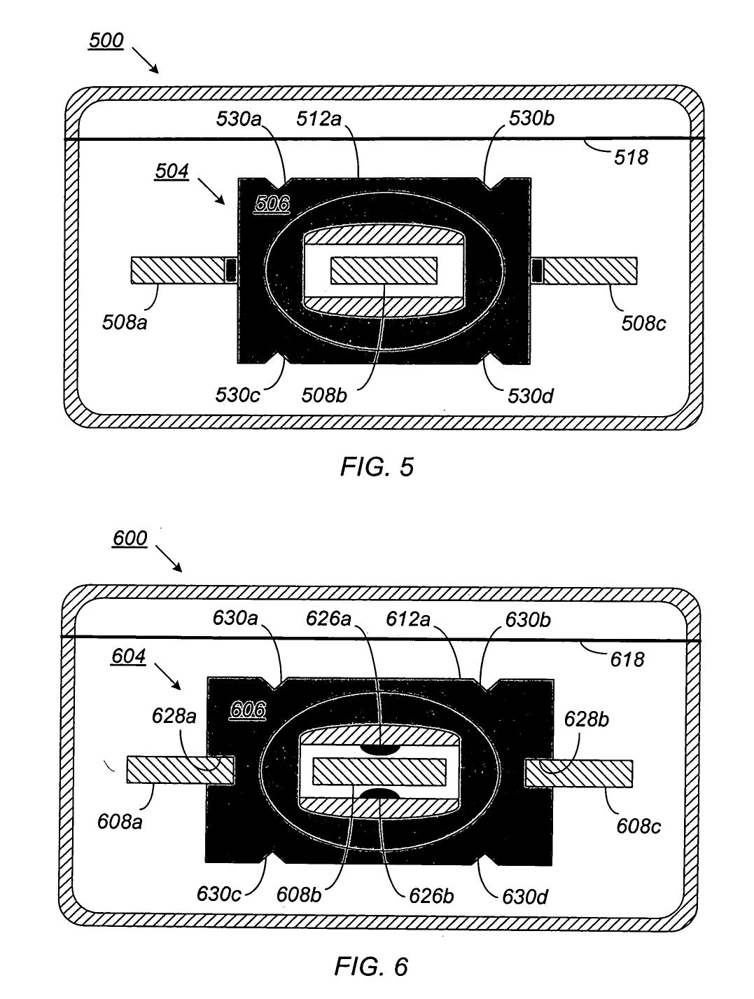

In some embodiments, the bobbin may include wire guides for guiding the lead wires of the coil that is formed on the bobbin. Referring now to FIG. 5, a receiver 500 having an electromagnetic drive assembly 504 with exemplary wire guides provided on the bobbin is shown. The electromagnetic drive assembly 504 is similar to the electromagnetic drive assembly 204 of FIGS. 2A-2B, except that it has a bobbin 506 which includes wire guides 530a-530d. The wire guides 530a-530d are formed as V-shaped grooves on one of the flanges 512a and 512b of the bobbin 506 and serve to guide the lead wires of the coil. Although there are four wire guides 530a-530d shown here, in practice, there may be more or fewer wire guides as needed, depending on the particular application. Also, the wire guides 530a-530d may be formed on one or on both flanges 512a and 512b, as needed. While a V-shaped groove is shown, other shape grooves may certainly be used, such as circular or rectangular grooves. Additionally, in some embodiments, a drop of adhesive may be placed in the grooves 530a-530d to help keep the lead wires in place on the flanges 512a and 512b.

Although they have been discussed separately thus far, all of the features above may be combined into a single receiver. FIG. 6 illustrates a cross-sectional view of a receiver 600 in which the electromagnetic drive assembly 604 has all of the features discussed above with respect to FIGS. 2A-2B and 3-5. The electromagnetic drive assembly 604 is similar to the electromagnetic drive assembly 204 of FIGS. 2A-2B, except that it has a bobbin 606 which includes shock-absorbing structures 626a and 626b, armature-mounting slots 628a and 628b, and wire guides 630a-630d. These features result in a receiver 600 that may be more shock resistant (because of the shock-absorbing structures), is easier to manufacture (by virtue of the self-centering armature), as well as more reliable (due to less handing of the coil and wires, since the bobbin can be handled now during manufacturing).

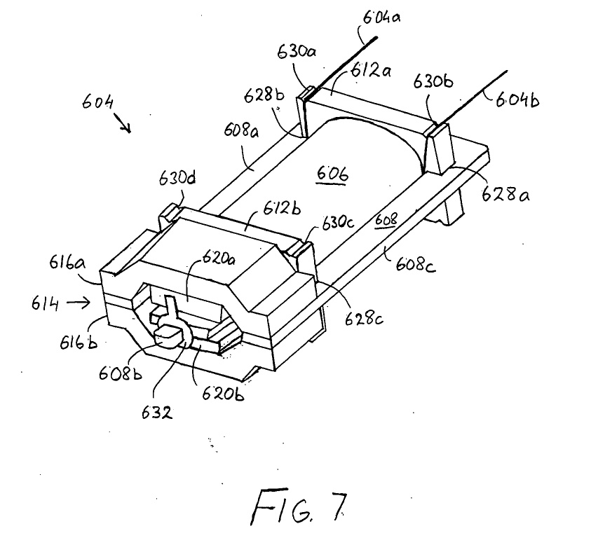

FIG. 7 illustrates a perspective view of the electromagnetic drive assembly 604 of FIG. 6. The electromagnetic drive assembly 604 includes the E-shaped armature 608 engaged to the bobbin 606 (although any of the bobbins previously discussed may be used). As a result, the electromagnetic drive assembly 604 enjoys the benefit of being more resistant to shock, having a self-aligning armature, as well as making it easier to retain the lead wires. The electromagnetic drive assembly 604 further includes a magnet assembly 614 that is similar to the magnet assembly 214 of FIG. 2A. The magnet assembly 614 is composed of magnet housings 616a and 616b, and magnets 620a and 620b that are housed within the magnet housing 616a and 616b. Outer armature legs 608a and 608c are then clamped between the magnet housing 616a and 616b. The coil assembly, which includes the bobbin 606 and its coiled wire, and the magnet assembly 614 define a passageway through which the moveable middle leg 608b of the armature 608 passes.

The magnet housing 616a and 616b help to position (i.e., balance) the armature 608 in the middle of the passageway of the coil and in the magnet gap between the magnets 620a and 620b. A drive pin 632 is connected to the armature 608 on one end and a diaphragm 618 (see FIG. 6) on the other end. When the coil receives a drive signal via lead wires 604a and 604b, the coil is energized in a manner that causes a known movement in the armature 608 and, thus, a known acoustic output from the diaphragm 618. The details of the function and operation of these components are well known to one having ordinary skill in this art and, therefore, will not be described here. Lead wires 604a and 604b are disposed in and retained by the V-shaped wire guides 630a-530b of the bobbin 606. Such an electromagnetic drive assembly 604 may be used in any miniature receiver of the type commonly employed in listening devices, such as hearing aids.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A receiver for a listening device, comprising:
a bobbin comprising a coil-receiving portion that is adapted to receive a coil of wire, said coil-receiving portion having inner surfaces that define a passage through said bobbin parallel to a longitudinal axis of said coil-receiving portion;
an armature disposed in said passage and adapted to generate an acoustic signal in response to an electrical signal passing through said coil of wire;
a diaphragm connected to said armature and driven by said armature to thereby broadcast said acoustic signal to an ear drum of a user of said listening device; and
at least one shock-absorbing structure mounted on one of said inner surfaces of said coil-receiving portion, said at least one shock-absorbing structure configured to limit a movement of said armature when said receiver is subjected to shock.

2. The receiver according to claim 1, wherein said at least one shock-absorbing structure comprises drops of cured adhesive.

3. The receiver according to claim 1, wherein said at least one shock-absorbing structure is made of an elastomeric material.

4. The receiver according to claim 1, wherein said at least one shock-absorbing structure and said bobbin are made from similar material.

5. The receiver according to claim 1, wherein said passage through said bobbin is defined entirely by said coil-receiving portion.

6. The receiver according to claim 1, wherein said passage through said bobbin is defined partially by said coil-receiving portion.

7. The receiver according to claim 1, further comprising first and second flanges on said bobbin, at least one of said first and second flanges having grooves formed on an edge thereof, said grooves for receiving lead wires of a wire wound around said coil-receiving portion.

8. The receiver according to claim 7, wherein said grooves are substantially V-shaped.

9. The receiver according to claim 7, further comprising slots formed on opposing edges of said first and second flanges, each opposing edge lying in a plane that is substantially perpendicular to said plane of said armature, said slots for receiving a portion of said armature.

10. The receiver according to claim 9, wherein said slots have a substantially rectangular shape.

11. A bobbin capable of guiding a lead wire of a coil, comprising:
first and second flanges;
a coil-receiving portion connecting said first and second flanges, said coil-receiving portion having said coil formed thereon;
wire guides formed on an edge of at least one of said first and second flanges, said wire guides configured to guide a lead wire of said coil.

12. The bobbin according to claim 11, wherein said wire guides are substantially V-shaped.

13. The bobbin according to claim 11, further including glue applied to said wire guides after said coil is formed to hold said lead wires in place.

14. A receiver for a listening device, comprising:
a magnet assembly;
an armature having a moveable portion and a fixed portion; and
a coil assembly including a bobbin and a conductive wire wound around said bobbin, said coil assembly being adjacent to said magnet assembly and, together with said magnet assembly, defining a passage through which said moveable portion passes, said bobbin including an armature-mounting structure, said moveable portion of said armature being substantially centered within said passage in response to said fixed portion being engaged to said armature-mounting structure.

15. The receiver according to claim 14, wherein said bobbin includes first and second flanges and said armature-mounting structure is formed on opposing edges of said first and second flanges, each opposing edge lying in a plane that is substantially perpendicular to a plane of said armature.

16. The receiver according to claim 14, wherein said armature-mounting structure has a shape that substantially matches a shape of said fixed portion of said armature.

17. The receiver according to claim 16, further comprising wire guides formed on an edge of at least one of said first and second flanges, said wire guides configured to hold lead wires of said conductive wire wound around said bobbin.

18. The receiver according to claim 14, wherein said armature is an E-shaped armature.

19. An electromagnetic drive assembly for a listening device, comprising:
a magnet assembly;
an armature having a moveable portion and a fixed portion;
a coil assembly including a bobbin and a conductive wire wound around said bobbin, said bobbin comprising a coil-receiving portion that, together with said magnet assembly, define a passage through which said moveable portion of said armature passes, said coil-receiving portion having a shock-absorbing structure mounted on an inner surface of said coil-receiving portion, said shock-absorbing structure configured to limit a movement of said moveable portion of said armature, said bobbin further comprising first and second flanges, said first and second flanges having wire guides formed on an edge of at least one of said first and second flanges, said wire guides configured to hold lead wires of said conductive wire, said first and second flanges further having armature-mounting structures formed on opposing edges of said first and second flanges, said armature-mounting structures configured to receive and support said fixed portion of said armature and to center said moveable portion of said armature in said passage; and
a drive pin connecting said armature to a diaphragm of said receiver.

20. A method of inhibiting deflection on an armature due to shock in a receiver for a listening device, comprising:
providing shock-absorbing elements on an inner surface of a bobbin through which said armature passes; and
limiting a movement of said armature resulting from said shock by engaging said armature on said shock-absorbing elements.

21. The method according to claim 20, further comprising bracing said armature by engaging at least a portion of said armature in an armature-mounting structure provided on said bobbin.

22. The method according to claim 21, wherein said step of bracing said armature also automatically centers said armature in said bobbin.

23. A method of assembling a receiver for a listening device, comprising:
winding a conductive wire around a bobbin, said bobbin having an armature-mounting structure formed thereon;
inserting a middle leg of an armature in said bobbin; and
placing at least one outer leg of said armature in said armature-mounting structure such that said middle leg of said armature is automatically centered in said bobbin.

24. The method according to claim 23, further comprising placing a lead wire of said conductive wire in a groove formed on said bobbin, said groove holding said lead wire on said bobbin.

25. The method according to claim 23, further comprising forming at least one shock-absorbing structure on an inner surface of said bobbin, said at least one shock-absorbing structure limiting a movement of said middle leg when said receiver is subjected to shock.
